(19) United States
(12) Patent Application Publication
(10) Pub. No.: US 2022/0400324 A1
(43) Pub. Date: Dec. 15, 2022

(54) LOUDSPEAKER ARRANGEMENT

(71) Applicant: Harman Becker Automotive Systems GmbH, Karlsbad (DE)

(72) Inventors: Ruslin TAMSIR, Cyberjaya (MY); Peter PODLOCZ, Debrecen (HU)

(73) Assignee: Harman Becker Automotive Systems GmbH, Karlsbad (DE)

(21) Appl. No.: 17/775,075

(22) PCT Filed: Nov. 8, 2019
(86) PCT No.: PCT/EP2019/080703

§ 371 Date: May 6, 2022

(51) Int. Cl. H04R 1/02; H04R 3/12

(52) U.S. Cl. CPC H04R 1/025; H04R 3/12; H04R 2201/028; H04R 2400/11; H04R 2499/13

(57) ABSTRACT

A loudspeaker arrangement comprises a frame including at least two mounting fixtures and a connecting element. The connecting element connects the at least two mounting fixtures to each other. The loudspeaker arrangement further comprises at least two loudspeakers. Each of the at least two loudspeakers is arranged in a different one of the at least two mounting fixtures. The loudspeaker arrangement further comprises an amplifier configured to amplify audio signals to be reproduced by the at least two loudspeakers. The amplifier is mechanically coupled to the connecting element between the at least two mounting fixtures.

### CROSS-REFERENCE TO RELATED APPLICATION

This application is the U.S. national phase of PCT Application No. PCT/EP2019/080703 filed on Nov. 8, 2019, the disclosure of which is hereby incorporated in its entirety by reference herein.

### TECHNICAL FIELD

The disclosure relates to a loudspeaker arrangement, in particular to a loudspeaker arrangement inside a vehicle.

### BACKGROUND

Vehicles today usually have a music system comprising a plurality of loudspeakers. Loudspeakers may be installed, for example, in a headrest or mounted on a wall or panel in a passenger compartment of the vehicle. As the loudspeakers in these cases are arranged distant to other components such as the corresponding playback (music) system, as well as any controlling devices (e.g., head unit or control unit), a considerable number of cables leading from a control unit to the loudspeakers are needed. The design of a headrest that can accommodate a loudspeaker enclosure, therefore, may be large and complicated.

### SUMMARY

A loudspeaker arrangement includes a frame including at least two mounting fixtures and a connecting element, wherein the connecting element connects the at least two mounting fixtures to each other. The loudspeaker arrangement further includes at least two loudspeakers, wherein each of the at least two loudspeakers is arranged in a different one of the at least two mounting fixtures. The loudspeaker arrangement further includes an amplifier configured to amplify audio signals to be reproduced by the at least two loudspeakers, wherein the amplifier is mechanically coupled to the connecting element between the at least two mounting fixtures.

Other systems, methods, features and advantages will be or will become apparent to one with skill in the art upon examination of the following detailed description and figures. It is intended that all such additional systems, methods, features and advantages be included within this description, be within the scope of the invention and be protected by the following claims.

### BRIEF DESCRIPTION OF THE DRAWINGS

The arrangement may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 schematically illustrates in a top view an example of a loudspeaker arrangement.

FIG. 2 schematically illustrates in a side view an example of a loudspeaker arrangement.

FIG. 3 schematically illustrates in a three-dimensional view another example of a loudspeaker arrangement.

FIG. 4 schematically illustrates in a top view the exemplary loudspeaker arrangement of FIG. 3.

FIG. 5 schematically illustrates in a three-dimensional view the rear side of the exemplary loudspeaker arrangement of FIG. 3.

FIG. 6 schematically illustrates in a side view the exemplary loudspeaker arrangement of FIG. 3.

FIG. 7 schematically illustrates in a side view a car seat with an exemplary loudspeaker arrangement mounted in the headrest.

FIG. 8 schematically illustrates in a front view a car seat with an exemplary loudspeaker arrangement mounted in the headrest.

FIG. 9 schematically illustrates in an exploded view another example of a loudspeaker arrangement.

### DETAILED DESCRIPTION

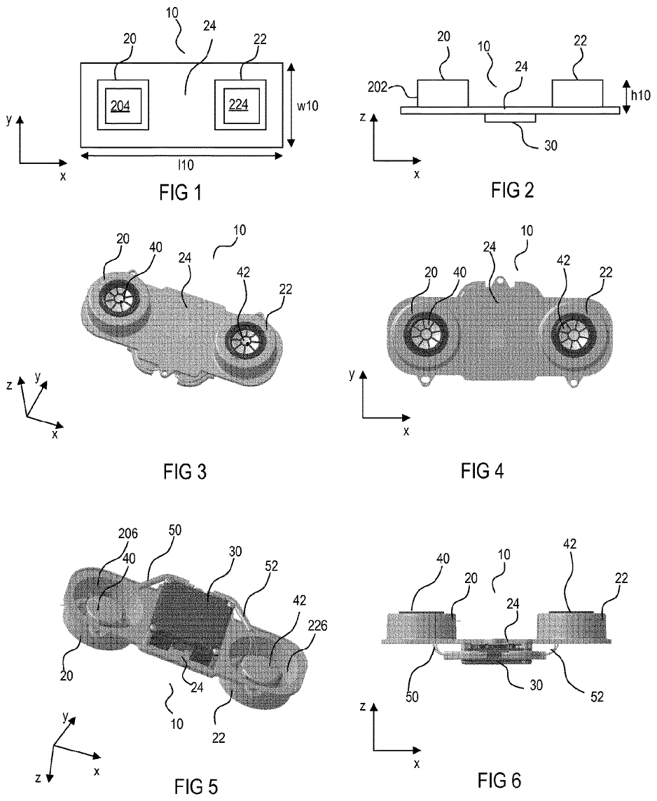

Referring to FIG. 1, a loudspeaker arrangement is schematically illustrated. The loudspeaker arrangement comprises a frame 10. The frame 10 comprises at least two mounting fixtures 20, 22 and a connecting element 24. Each of the at least two mounting fixtures 20, 22 is configured to receive a loudspeaker. The at least two mounting fixtures 20, 22 are connected by the connecting element 24 which extends in a horizontal plane (x-y) between the at least two mounting fixtures 20, 22. Each of the at least two mounting fixtures 20, 22 may have a square, a rounded, an oval or a polygonal cross-section. In the example illustrated in the Figures and described below, the at least two mounting fixtures 20, 22 have a rounded cross-section.

Each mounting fixture 20, 22 comprises circumferential sidewalls 202, 222 (see, e.g., FIG. 2). The sidewalls 202 222 extend from a first side of the connecting element 24 in a vertical direction z. The sidewalls 202, 222 form a casing that is configured to receive a loudspeaker. Each of the mounting fixtures 20, 22 is open towards the vertical direction z on both sides. That is, each mounting fixture 20, 22 comprises a first opening 204, 224 on a front side of the loudspeaker arrangement, that is, on the first side of the connecting element 24. Each mounting fixture 20, 22 further comprises a second opening 206, 226 on a rear side of the loudspeaker arrangement, that is, towards a second side of the connecting element 24, the second side being opposite to the first side.

The connecting element 24 may be a flat connection piece extending in a horizontal plane (x-y) between the mounting fixtures 20, 22. That is, the connecting element 24 may have the form of a connection plate or panel. The connecting element 24 may have a thickness in the vertical direction z which is significantly smaller than its length and width in a first and second horizontal directions x, y.

Now referring to FIG. 3, the loudspeaker arrangement further comprises at least two loudspeakers 40, 42. Each of the at least two loudspeakers 40, 42 is arranged in a different one of the at least two mounting fixtures 20, 22. That is, each loudspeaker 40, 42 is enclosed at least horizontally by one of the mounting fixtures 20, 22, in particular by the circumferential sidewalls 202, 222 of the respective mounting fixture 20, 22.

The loudspeaker arrangement further comprises an amplifier 30. The amplifier 30 is mechanically coupled to the frame 10. In particular, the amplifier 30 is arranged on and connected to the second side of the connecting element 24. Thus, while the mounting fixtures 20, 22 with the loudspeakers 40, 42 arranged therein extend from the first side of the connecting element 24, the amplifier 30 extends from the second side of the connecting element 24, that is, the amplifier extends in an opposite direction as compared to the mounting fixtures 20, 22. This, however, is only an example. Generally, it is also possible that the amplifier 30 is arranged on and connected to the first side of the connecting element 24 between the at least two mounting fixtures 20, 22. However, as will become apparent from the description below, arranging the amplifier 30 on and connected to the second side allows to electrically couple the amplifier 30 to the at least two loudspeakers 40, 42 in an easy and space-saving manner. The amplifier 30 is electrically coupled to each of the at least two loudspeakers 40, 42. The amplifier 30 is configured to amplify an audio signal that is to be played by the at least two loudspeakers 40, 42. The audio signal may be received by the amplifier 30 from a sound system that is arranged distant from the loudspeaker arrangement.

While FIG. 3 schematically illustrates a three-dimensional view of an exemplary loudspeaker arrangement, FIG. 4 schematically illustrates a top view, FIG. 5 schematically illustrates another three-dimensional view illustrating a back-side (second side) of the loudspeaker arrangement, and FIG. 6 schematically illustrates a side view of the exemplary loudspeaker arrangement. In FIGS. 3 and 4, a top part, for example, a loudspeaker grille, of each of the at least two loudspeakers 40, 42 is visible through the first openings 204, 224. The remaining parts of the at least two loudspeakers 40, 42 are not visible in these views, as such components are hidden behind the corresponding mounting fixtures 20, 22. In FIG. 5, a back side of the at least two loudspeakers 40, 42 is visible through the second openings 206, 226 of the at least two mounting fixtures on the rear side of the loudspeaker arrangement. Cables or wiring harnesses 50, 52 are used to provide an electrical connection between the at least two loudspeakers 40, 42 and the amplifier 30. If the amplifier 30 is arranged on the rear side (second side) of the connecting element 24, the cables or wiring harnesses 50, 52 may be easily led from the amplifier 30 through the second openings 206, 226 to the respective loudspeakers 40, 42.

As can be seen from the example illustrated in FIGS. 3 to 6, the loudspeaker arrangement may be implemented in a compact way. The main components, that is the at least two loudspeakers 40, 42 and the amplifier 30 are all mounted to the frame 10. The wiring harnesses 50, 52 that are used to electrically couple the loudspeakers 40, 42 to the amplifier 30 are comparably short. That is, a length of each of the wiring harnesses 50, 52 between one of the loudspeakers 40, 42 and the amplifier 30 may be less than 30 cm, less than 20 cm or even less than 10 cm, for example. Each wiring harness 50, 52 may comprise at least two separate cables. Such cables may be used to provide the loudspeakers 40, 42 with power and to provide the audio signal to the loudspeakers 40, 42. An additional wiring harness (not specifically illustrated) may be used to electrically couple the amplifier to a sound system. However, such an additional wiring harness may only comprise a limited number of cables. Therefore, even if a length of such an additional wiring harness connecting the amplifier 30 to a sound system is comparably long, for example, greater than 1 m, greater than 2 m, or even greater than 3 m, not much space is needed to arrange the wiring harness between the sound system and the loudspeaker arrangement within the vehicle.

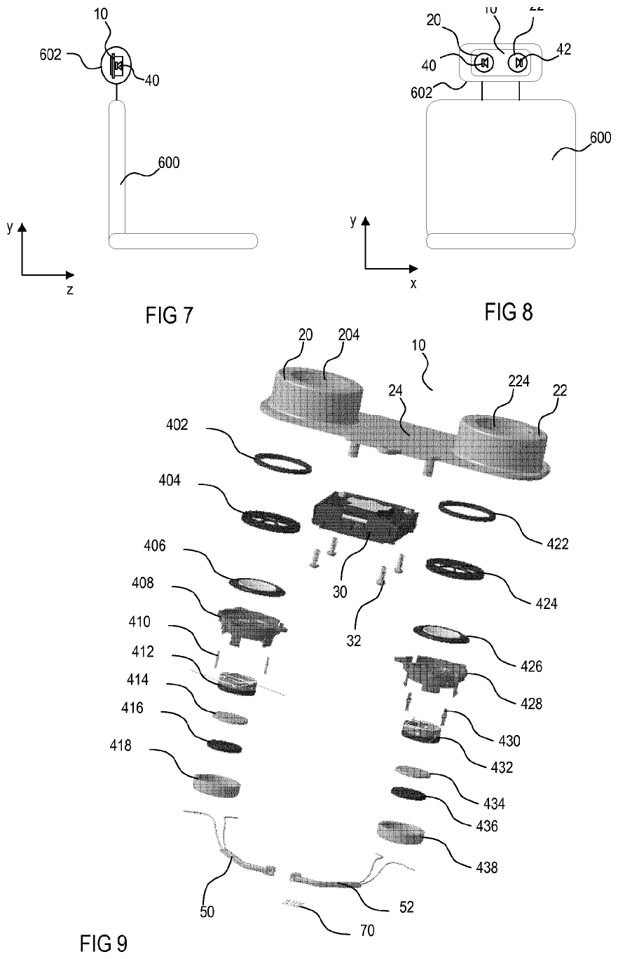

In one example and as mentioned above, the loudspeaker arrangement may be arranged in a headrest 602 of a vehicle. FIG. 7 schematically illustrates a side view of a car seat 600 comprising a headrest 602, with a loudspeaker arrangement mounted within the headrest. Thus, sound (e.g., music, speech, warning signals, etc.) may be output in direct proximity to a user's ears. The at least two loudspeakers 40, 42 are arranged at a certain distance from each other such that a first one of the at least two loudspeakers 40 may radiate sound primarily to a first ear of the user, and a second one of the at least two loudspeakers 42 may radiate sound primarily to a second ear of the user. The distance between the loudspeakers 40, 42 is set by the dimensions of the connecting element 24, which defines a distance between the mounting fixtures 20, 22 and, therefore, between the loudspeakers 40, 42. FIG. 8 schematically illustrates a front view of the arrangement of FIG. 7. In this front view the arrangement of the loudspeakers 40, 42 close to the positions of a user's ears can be clearly seen.

Now referring to FIG. 9, an exploded view of an exemplary loudspeaker arrangement is schematically illustrated. The frame 10 including the at least two mounting fixtures and the connecting element 24 essentially corresponds to the frame as illustrated in FIGS. 3 to 6. As can be seen in FIG. 9, the amplifier 30 may be mounted on the frame by via fastening elements 32. Such fastening elements 32 may comprise one or more screws (see FIG. 9), or at least one bracket (not specifically illustrated), for example. Any other suitable fastening elements 32 are generally possible. According to another example, the amplifier 30 may be glued to the frame 10 via an adhesive layer (not illustrated).

In FIG. 9, different components forming the at least two loudspeakers 40, 42 are illustrated in greater detail. The components illustrated in FIG. 9, however, are only examples. The loudspeakers 40, 42 may comprise additional components, some of the described components may be omitted or some of the described components may be replaced by alternative components. Each loudspeaker 40, 42 in the example of FIG. 9 comprises a front gasket 402, 422 and a loudspeaker grille 404, 424. The first opening of each of the at least two mounting fixtures 20, 22 may be covered by the loudspeaker grille 404, 424 of one of the at least two loudspeakers 40, 42, for example. That is, when the loudspeakers 40, 42 are mounted in the mounting fixtures 20, 22, the first opening 204, 224 may be covered by the grille 404, 424, while the second opening 206, 226 may remain open. Each loudspeaker 40, 42 further comprises a loudspeaker dome 406, 426 that, at its perimeter, may be surrounded by a foam material. Each loudspeaker 40, 42 may further comprise a loudspeaker basket 408, 428, a voice coil 412, 432, as well as terminals 410, 430 configured to connect the voice coil 412, 432 to the respective loudspeaker basket 408, 428. Each loudspeaker 40, 42 further comprises a core cap 414, 434 and a magnet 416, 436, as well as a shell pot 418, 438. FIG. 9 also illustrates the wiring harnesses 50, 52 that have already been described above. The frame 10 may further be labeled by affixing a label 70 to the connecting element 24, for example. The label 70 may provide information on the manufacturer and the model of the loudspeaker arrangement, for example. The described components may form a conventional loudspeaker. Any other suitable kind of loudspeaker, however, may be used instead.

The loudspeaker arrangement as described above provides a very compact construction. The loudspeaker arrangement may be arranged in a headrest 602 of a vehicle, for example, or anywhere else within the vehicle. If the loudspeaker arrangement is arranged distant from a sound system of the vehicle, only a limited number or wire connections is required in order to electrically couple the loudspeaker arrangement to the sound system. The number of wire connections is greatly reduced due to the compact arrangement in which the amplifier is arranged close to the loudspeakers 40, 42. If instead the amplifier was arranged distant from the loudspeaker arrangement (e.g., loudspeakers arranged in headrest and amplifier arranged close to sound system), the required number of wire connections would be significantly larger. Distant from the loudspeaker arrangement in this context refers to a distance of at least 50 cm, at least 1 m, or at least 2 m between the loudspeakers and the amplifier. Laying cables between the sound system of a vehicle and loudspeakers arranged in a headrest 602 of the vehicle is generally challenging, as there are only comparatively small connecting elements connecting the headrest to the car seat. That is, it is generally not possible to lay a large number of cables from a sound system to loudspeakers 40, 42 in a head rest of the vehicle.

The at least two loudspeakers 40, 42 are received by the mounting fixtures 20, 22 of the frame 10. The amplifier 30 is mounted on the frame 10 as well. This compact loudspeaker arrangement may be installed into and removed from the head rest easily and with minimal effort. Any required cables may be easily stowed within the headrest and the car seat. The loudspeaker arrangement is compatible with all different kinds and shapes of headrests and is not restricted to any specific shape or model.

The loudspeaker arrangement as described above comprises two mounting fixtures 20, 22 and two loudspeakers 40, 42. This, however, is only an example. It is generally possible that the arrangement comprises more than two mounting fixtures 20, 22 and more than two loudspeakers 40, 42, if required.

In one example, the frame 10 may include a plastic material, or a metal. According to one example, the frame 10 comprises or is formed from polycarbonate. According to one example, the frame 10 may be a single piece. In one example, the at least two mounting fixtures 20, 22 and the connecting element 24 may be integrally formed by using a casting or molding process.

The frame 10 may have a length 110 in a first horizontal direction x, a width w10 in a second horizontal direction y, and a height h10 in the vertical direction z. According to one example, the length 110 is between 150 mm and 350 mm, the width w10 is between 70 mm and 160 mm, and the height h10 is between 25 mm and 100 mm.

While various embodiments of the invention have been described, it will be apparent to those of ordinary skill in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof. Accordingly, the invention is not to be restricted except in light of the attached claims and their equivalents.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should be understood as not excluding plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature, and may include additional elements and/or omit elements. The subject matter of the present disclosure includes all novel and non-obvious combinations and sub-combinations of the various systems and configurations, and other features, functions, and/or properties disclosed. The following claims particularly point out subject matter from the above disclosure that is regarded as novel and non-obvious.

1. A loudspeaker arrangement comprising:
a frame comprising at least two mounting fixtures and a connecting element, wherein the connecting element connects the at least two mounting fixtures to each other;
at least two loudspeakers, wherein each of the at least two loudspeakers is arranged in a different one of the at least two mounting fixtures, and
an amplifier configured to amplify audio signals to be reproduced by the at least two loudspeakers, wherein the amplifier is mechanically coupled to the connecting element between the at least two mounting fixtures.

2. The loudspeaker arrangement of claim 1, wherein
the connecting element is a flat connecting piece extending in a horizontal plane between the at least two mounting fixtures; and
each of the at least two mounting fixtures is configured to form a casing for one of the at least two loudspeakers.

3. The loudspeaker arrangement of claim 1, wherein
the at least two mounting fixtures extend from a first side of the connecting element in a vertical direction; and
the amplifier is arranged on a second side of the connecting element, the second side being opposite to the first side.

4. The loudspeaker arrangement of claim 1, further comprising at least one fastening element configured to secure the amplifier to the connecting element.

5. The loudspeaker arrangement of claim 4, wherein the at least one fastening element comprises at least one screw or bracket.

6. The loudspeaker arrangement of claim 1, further comprising at least two wiring harnesses being configured to electrically couple one of the at least two loudspeakers to the amplifier.

7. The loudspeaker arrangement of claim 1, wherein
each of the at least two mounting fixtures comprises circumferential sidewalls extending from a first side of the connecting element in a vertical direction,
each of the at least two mounting fixtures comprises a first opening on a front side of the loudspeaker arrangement on the first side of the connecting element, and
each of the at least two mounting fixtures comprises a second opening on a rear side of the loudspeaker arrangement on a second side of the connecting element.

8. The loudspeaker arrangement of claim 7, wherein
each of the at least two loudspeakers comprises a loudspeaker grille, and
the first opening of each of the at least two mounting fixtures is covered by the loudspeaker grille of one of the at least two loudspeakers.

9. The loudspeaker arrangement of claim 1, wherein each of the at least two mounting fixtures has a square, a rounded, an oval or a polygonal cross-section.

10. The loudspeaker arrangement of claim 1, wherein the at least two mounting fixtures and the connecting element are integrally formed.

11. The loudspeaker arrangement of claim 1, wherein the at least two mounting fixtures and the connecting element are formed using a first material, wherein the first material comprises one of a plastic material or a polycarbonate.

12. (canceled)

13. The loudspeaker arrangement of claim 1, wherein the frame includes a length in a first horizontal direction, a width in a second horizontal direction, and a height in the vertical direction, wherein
the length is between 150 mm and 350 mm;
the width is between 70 mm and 160 mm; and
the height is between 25 mm and 100 mm.

14. A loudspeaker arrangement comprising:
a frame including a connecting element;
at least two mounting fixtures being connected to one another by the connecting element;
at least two loudspeakers, wherein each of the at least two loudspeakers is arranged in a different one of the at least two mounting fixtures, and
an amplifier mechanically coupled to the connecting element between the at least two mounting fixtures and being configured to amplify audio signals provided by the at least two loudspeakers.

15. The loudspeaker arrangement of claim 14, wherein
the connecting element is a flat connecting piece extending in a horizontal plane between the at least two mounting fixtures; and
each of the at least two mounting fixtures is configured to form a casing for one of the at least two loudspeakers.

16. The loudspeaker arrangement of claim 14, wherein
the at least two mounting fixtures extend from a first side of the connecting element in a vertical direction; and
the amplifier is arranged on a second side of the connecting element, the second side being opposite to the first side.

17. The loudspeaker arrangement of claim 14 further comprising at least one fastening element configured to secure the amplifier to the connecting element.

18. The loudspeaker arrangement of claim 17, wherein the at least one fastening element comprises at least one screw or bracket.

19. The loudspeaker arrangement of claim 14, further comprising at least two wiring harnesses being configured to electrically couple one of the at least two loudspeakers to the amplifier.

20. The loudspeaker arrangement of claim 14, wherein
each of the at least two mounting fixtures comprises circumferential sidewalls extending from a first side of the connecting element in a vertical direction,
each of the at least two mounting fixtures comprises a first opening on a front side of the loudspeaker arrangement on the first side of the connecting element, and
each of the at least two mounting fixtures comprises a second opening on a rear side of the loudspeaker arrangement on a second side of the connecting element.

21. A loudspeaker arrangement comprising:
a frame including a connecting element;
at least two mounting fixtures being connected to one another by the connecting element;
at least two loudspeakers, wherein each of the at least two loudspeakers is arranged in a different one of the at least two mounting fixtures, and
an amplifier coupled to the connecting element about the at least two mounting fixtures and being configured to amplify audio signals provided by the at least two loudspeakers.
